(19) United States
(12) Patent Application Publication
(10) Pub. No.: US 2010/0188674 A1
(43) Pub. Date: Jul. 29, 2010

(54) ADDED IMAGE PROCESSING SYSTEM, IMAGE PROCESSING APPARATUS, AND ADDED IMAGE GETTING-IN METHOD

(75) Inventor: Hajime Tomizawa, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/683,152

(22) Filed: Jan. 6, 2010

Related U.S. Application Data
(60) Provisional application No. 61/147,268, filed on Jan. 26, 2009.

(30) Foreign Application Priority Data
Oct. 5, 2009 (JP) 2009-231172

(51) Int. Cl. G06F 15/00; G06K 9/68

(52) U.S. Cl. 358/1.9; 382/218

(57) ABSTRACT

According to one embodiment, an added image processing system includes a document storing portion configured to store a document file which is electronic information, an added image obtaining portion configured to obtain a difference in case comparing a document file stored in the document storing portion identified on the basis of a scanned image obtained by scanning a paper document with the scanned image as an added image, a corresponded text obtaining portion configured to obtain a text corresponding to the added image obtained by the added image obtaining portion, a text metadata obtaining portion configured to obtain text metadata of the corresponded text, an added image storing portion configured to store the corresponded text, the text metadata, and the added image in relation to each other, an added image getting-in portion, on the basis of the text metadata, configured to add the added image stored in the added image storing portion to a new document file, and a text metadata selecting portion configured to select an attribute considered in case adding the added image to the new document file by the added image getting-in portion.

### CROSS-REFERENCE TO RELATED APPLICATION

This application is based upon and claims the benefit of priority from U.S. provisional application 61/147268, filed on Jan. 26, 2009; the entire contents of each of which are incorporated herein by reference.

This application is also based upon and claims the benefit of priority from Japanese Patent Application No. 2009-231172, filed on Oct. 5, 2009; the entire contents of which are incorporated herein by reference.

### TECHNICAL FIELD

The exemplary embodiments described herein relate to the added image processing system, image forming apparatus, and added image getting-in method.

### BACKGROUND

A paper document printed by the image forming apparatus may be written by a user. The arts for scanning a document written by a user like this and extracting and using the image of the portion written from the scanned image are proposed.

As one of the arts, the art disclosed in U.S. Patent Application Publication No. 2006/0044619 may be cited. In U.S. Patent Application Publication No. 2006/0044619, the art, when printing an electronic document, for giving the information of identifying the electronic document to a paper document, thereby extracting the written image, and then selecting and printing a document reflecting an entry to the electronic document such as only a document only written in the paper document or an original document is disclosed. Further, in Japanese Patent Application Publication No. 2006-65524, to give the related information and access authority information of each entry person to the entry in the paper document, thereby prepare a document with only a part of the entry left is recorded.

However, in U.S. Patent Application Publication No. 2006/0044619, the entry in the paper document is related to the document itself, so that in another document using a part of the text of the document, the entry cannot be put. Therefore, the reusability of the entry is restricted.

Furthermore, if the text and entry are only related to each other, when there are many same texts in the document, all the texts are written. Namely, among the same texts in the document, the entry cannot be added only to the text aimed at by the user, thus the reusability of the entry may be said to be short of convenience.

### SUMMARY

An aspect of the present disclosure relates to an added image processing system, containing: a document storing portion configured to store a document file to be electronic information; an added image obtaining portion configured to obtain a difference in case comparing the document file stored in the document storing portion identified on the basis of a scanned image obtained by scanning a paper document with the scanned image as an added image; a corresponded text obtaining portion configured to obtain a text corresponding to the added image obtained by the added image obtaining portion; a text metadata obtaining portion configured to obtain text metadata of the corresponded text; an added image storing portion configured to store the corresponded text, the text metadata, and the added image in relation to each other; an added image getting-in portion, on the basis of the text metadata, configured to add the added image stored in the added image storing portion to a new document file; and a text metadata selecting portion configured to select an attribute considered in case adding the added image to the new document file by the added image getting-in portion.

Further, an aspect of the present disclosure relates to an added image processing system, containing: a document storing memory to store a document file to be electronic information; a scanned image memory to store a scanned image obtained by scanning a paper document; an added image storing memory to obtain a difference in case comparing the document file of the document storing memory identified on the basis of the scanned image with the scanned image as an added image and storing the text metadata of the corresponded text corresponding to the added image and the added image in relation to each other; and a controller, on the basis of the text metadata, to control to add the added image stored in the added image storing memory to a new document file and select an attribute considered in case adding the added image.

Further, an aspect of the present disclosure relates to an added image getting-in method, containing: storing a document file to be electronic information; obtaining a scanned image of a paper document scanned; obtaining a document file corresponding to the scanned image as an originated print document file from the stored document file; obtaining a difference in case comparing the originated print document file with the scanned image as an added image and obtaining a text in the originated print document file corresponding to the added image; storing the text metadata of the corresponded text and the added image in relation to each other; selecting an attribute considered in case adding the added image to the document file; and adding the stored added image to the document file on the basis of the selected attribute and the text metadata.

### BRIEF DESCRIPTION OF THE DRAWINGS

FIG. 1 is a block diagram showing the added image processing system of the first embodiment;

FIG. 2 is a block diagram showing the processing portion of the added image processing system of the first embodiment;

FIG. 3 is an example of the storing format of a document stored in the document storing portion;

FIG. 4 is an output image diagram of a document file D1;

FIG. 5 is an image diagram of a paper document that an added image is added to the document file D1;

FIG. 6 is a flow chart showing the extraction process of the added image;

FIG. 7 is an image diagraph showing an example of the storing format of the added image;

FIG. 8 is an image diagram of a display screen of the document browsing application;

FIG. 9 is an output image diagram of a document file 904;

FIG. 10 is a flow chart showing the text metadata selection getting-in process;

FIG. 11 is an image diagram of an evaluation metadata item selection screen;

FIG. 12 is an image diagram of a document file that the added image is added to the document file 904;

FIG. 13 is an image diagram of the document file 904 added with the added image converted to a text character string;

FIG. 14 is a block diagram showing the added image processing system of the second embodiment;

FIG. 15 is a block diagram showing the processing portions of the added image processing system of the second embodiment;

FIG. 16 is a block diagram showing the processing portion of the added image processing system of the third embodiment;

FIG. 17 is a flow chart showing the added image getting-in method process;

FIG. 18 is an image diagram of an added image getting-in method selection screen;

FIG. 19 is an image diagram of a document file of the third embodiment;

FIG. 20 is an image diagram of a document file with the added image added by “Overwrite”;

FIG. 21 is an image diagram of a document file with the added image added by “Insert”; and

FIGS. 22A and 22B are image diagrams of a document file with the added image added by “Mark”.

### DETAILED DESCRIPTION

Hereinafter, the embodiments will be explained with reference to the embodiments.

First Embodiment

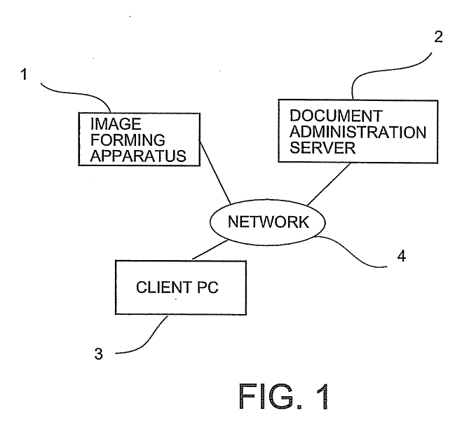

The first embodiment will be explained by referring to FIGS. 1 to 12.

FIG. 1 is a block diagram showing the constituent units of the added image processing system.

The added image processing system is composed of an image forming apparatus 1, a document administration server, and a client PC 3. These units are connected by a network 4 and transfer information.

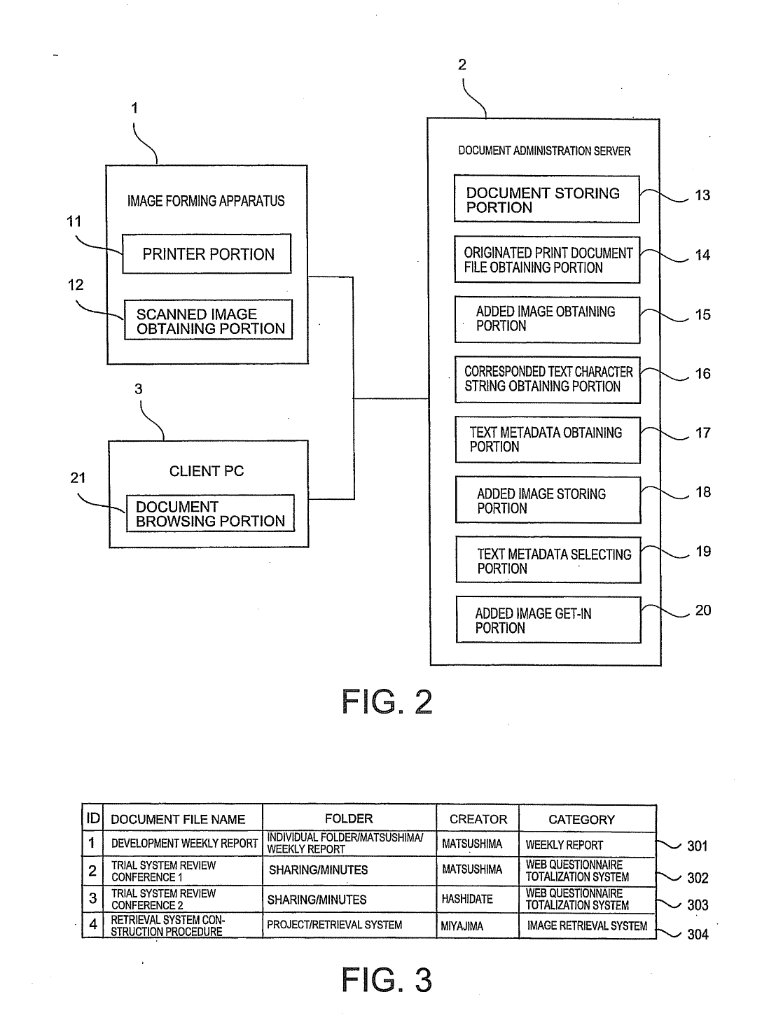

FIG. 2 is a block diagram showing the processing portions included in the added image processing system.

The image forming apparatus 1 includes a printer portion 11 for printing a document and a scanned image obtaining portion 12 for scanning a paper document and obtaining a scanned image. The document administration server 2 includes a document storing portion 13, an originated print document file obtaining portion 14, an added image obtaining portion 15, a corresponded text character string obtaining portion 16, a text metadata obtaining portion 17, an added image storing portion 18, a text metadata selecting portion 19, and an added image getting-in portion 20. The client PC 3 has a document browsing portion 21.

Next, the processing portions included in the document administration server 2 and the client PC 3 will be explained.

The document storing portion 13 stores a document file which is electronic information together with metadata such as the ID for uniquely identifying the document file, creator of the document file, creation date, and categories. FIG. 3 shows an example of the storing format of the document stored in the document storing portion 13. FIG. 3 shows document files 301 to 304. Such document files are stored in the document storing portion 13 together with the metadata.

The originated print document file obtaining portion 14 obtains the originated print document file which is a document file as an origin of the scanned image obtained by the scanned image obtaining portion 12.

The added image obtaining portion 15 compares the scanned image obtained by the scanned image obtaining portion 12 with the originated print document file obtained by the originated print document file obtaining portion and obtains the portion having a difference as an added image.

The corresponded text character string obtaining portion 16 identifies a text character string of the originated print document file to which the added image obtained by the added image obtaining portion 15 corresponds and obtains the identified character string. And, the text metadata obtaining portion 17 analyzes the metadata included in the text character string obtained by the corresponded text character string obtaining portion 16 and obtains the analyzed metadata.

The added image storing portion 18 stores the added image obtained by the added image obtaining portion 15 together with the corresponded text character string and the text metadata thereof. The text metadata selecting portion 19 enables writing only in the text aimed at by the user. Thereafter, the added image getting-in portion 20, when there is a text character string to which the added image is related in the document data, can add the added image stored in the added image storing portion 18 to the document file.

The document browsing portion 21 is a portion for indicating the information stored in the document storing portion 13 and the added image storing portion 18 to the user.

The added image can be added to the document file using the respective processing portions explained above. The detailed flow up to addition of the added image to the document file will be indicated below.

The user accesses the document administration server 2 from the client PC 3 and can refer to the document list stored in the document storing portion 13 by the display of the client PC. And, the user designates the document file to be printed from the document list at the client PC 3. Then, the document file designated by the user is printed by a printer portion 11 of the image forming apparatus 1 and a paper document is output.

Here, when printing the document file stored in the document storing portion 13, the information capable of identifying the printed document file such as the file name of the target document file, storing folder, and printed page range is converted, for example, to a code such as a bar code, is added to a paper document, and then is output. When scanning the paper document by the bar code, the document file which is an originated print can be identified.

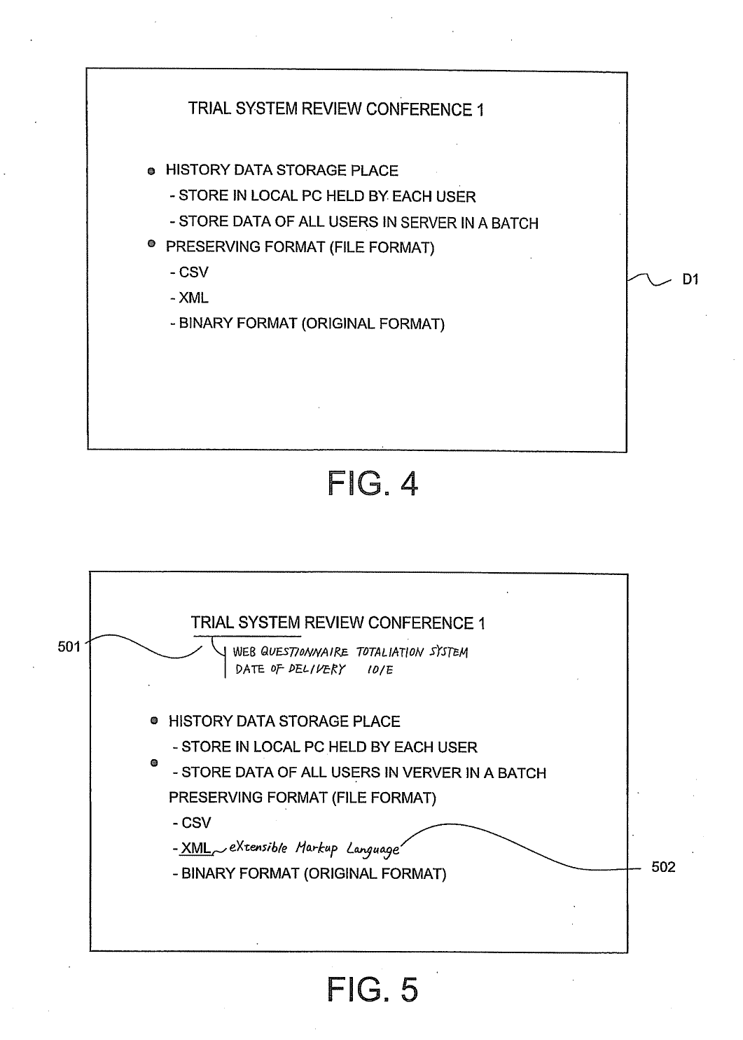

On the paper document printed in this way, the user can execute writing using a writing tool. For example, the document file D1 shown in FIG. 4 is stored by the document storing portion 13. The document file Dl is assumed to be printed by the user. A paper document printed and outputted to which the user adds a written image is shown in FIG. 5. Namely, to a text of “Trial system”, a handwritten note of “Web questionnaire totalization system, date of delivery—10/E” is added. The handwritten postscript is assumed to be named as an added image 501. Further, to a text of “XML”, a handwritten postscript of “eXtensible Markup Language” is added. This is assumed to be named as an added image 502.

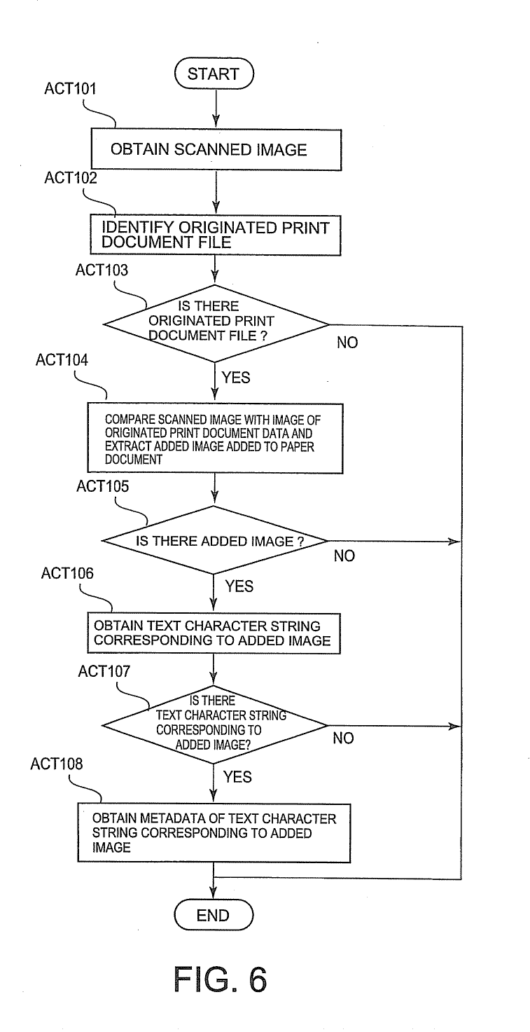

Next, the process of extracting the image added (added image) from the paper document to which the handwritten postscript is added will be explained using the flow chart shown in FIG. 6.

Firstly, at ACT 101, the scanned image obtaining portion 12 obtains the scanned image. This time, the scanned image of the paper document to which the postscript of the handwritten image shown in FIG. 5 is added is obtained. The scanned image is sent to the document administration server 2 via the network 4.

Next, at ACT 102, the originated print document file obtaining portion 14 obtains at ACT 101 the document file which is an origin of the paper document scanned (hereinafter, referred to as an originated print document file). When the document shown in FIG. 5 is scanned, the originated print document file obtaining portion 14 obtains the document file D1 shown in FIG. 4 as an originated print document file.

As one of the methods for concretely obtaining the originated print document file, a method for reading a bar code for identifying the document file recorded in the paper document may be cited. The method is enabled, as mentioned above, by adding the bar code for identifying the document file when printing the paper document.

Further, when no bar code is given to the paper document, the originated print document file obtaining portion 14 may obtain the document file closest to the scanned image using the similar image retrieval executed by the document storing portion 13. Or, the originated print document file obtaining portion 14 may permit the user to directly designate the originated print document file from the document files stored by the document storing portion 13. In this case, the originated print document file obtaining portion 14 indicates the document file list stored in the document storing portion 13 to the user and provides an UI (user interface) to be selected.

At ACT 103, the originated print document file obtaining portion 14 judges whether the originated print document file of the scanned image is stored in this way in the document storing portion 13 or not. When the originated print document file of the scanned image is not stored in the document storing portion 13 (NO at ACT 103), the extraction process of the added image is finished.

When the originated print document file is decided to be stored in the document storing portion 13 (YES at ACT 103), the process goes to ACT 104 and the added image obtaining portion 15 compares the scanned image with the originated print document file and extracts the image added to the paper document as an added image.

The added image obtaining portion 15 compares the scanned image obtained at ACT 101 with the originated print document file obtained at ACT 102 and detects a difference (at ACT 104). The difference detected here is detected as an added image. In this case, the added image obtaining portion 15 compares the image shown in FIG. 5 with the originated print document file D1 shown in FIG. 4 and obtains the difference. Further, when extracting the added image which is a difference, the added image is separated as a mass whole to be grouped. As a result, in this case, two added images such as the added image 501 and added image 502 can be obtained.

Next, at ACT 105, the added image obtaining portion 15 decides whether there is an added image or not. When there is no difference at ACT 104 between the scanned image and the originated print document file, the added image obtaining portion 15 judges that there is no added image (NO at ACT 105) and finishes the added image extracting process.

When the difference is detected at ACT 104 between the scanned image and the originated print document file, that there is an added image is judged (YES at ACT 105) and the process goes to ACT 106.

At ACT 106, the corresponded text character string obtaining portion 16 obtains the text character string in the originated print document file corresponding to the added image extracted at ACT 104. On the added image 501 of the image shown in FIG. 5, an underline is drawn under the text character string of “Trial system” and at the end of the draw-out line extended, the added image 501 of “Web questionnaire totalization system, date of delivery—10/E” is added. The corresponded text character string obtaining portion 16 analyzes the added image 501 and detects the underlined portion of the added image 501. Furthermore, the text character string underlined from the underlined portion detected is obtained from the originated print document file.

From this process, the text character string of “Trial system” is judged to correspond to the added image 501. The corresponded text character string obtaining portion 16 performs such a process for all the added images extracted at ACT 104 and obtains the text character strings (corresponded text character strings) corresponding to the added images. Also for the added image 52, the underlined portion is detected similarly and the corresponded text character string “XML” can be extracted from the originated print document file.

Further, for the added image 501 and added image 502, the underline is extracted and the corresponded text character string is obtained. However, instead of the underline, the circle mark enclosing the text character string is detected, thus the corresponded text character string may be obtained. Further, a threshold value of the distance between the added image and the text character string is set and if the distance between the added image and the text character string is equal to or smaller than the threshold value, the text character string may be judged as a corresponded text character string corresponding to the added image.

Next, the corresponded text character string obtaining portion 16 judges at ACT 107 whether the text character string corresponding to the added image can be obtained or not at ACT 106. The corresponded text character string obtaining portion 16, if the corresponded text character string corresponding to the added image is not obtained (NO at ACT 107), finishes the added image extracting process. If even one corresponded text character string corresponding to the added image can be obtained (YES at ACT 107), the process goes to ACT 108. Further, among the added images obtained at ACT 104, the added image the corresponded text character string corresponding to which cannot be obtained at ACT 106 is ignored in the subsequent process.

At ACT 108, the text metadata obtaining portion 17 obtains the metadata of the corresponded text character string obtained at ACT 106. As one of the metadata of the corresponded text character string, the layout attributes such as “Heading”, “Text”, and “Header” may be cited. The layout attributes are judged from the size and position of the text character string in the document file. For example, if the text character string has a large font size and exists on the upper part of the page, the text character string is decided as a “heading”.

As metadata of another corresponded text character string, metadata such as “storing folder” indicating the storing folder storing the originated print document file, “creator” preparing the document file, or “category” of the document decided by the user may be obtained.

The extraction of the added image added to the paper document is performed in the aforementioned flow.

Next, the process of adding the added image stored in the added image storing portion 18 to a new document file will be explained.

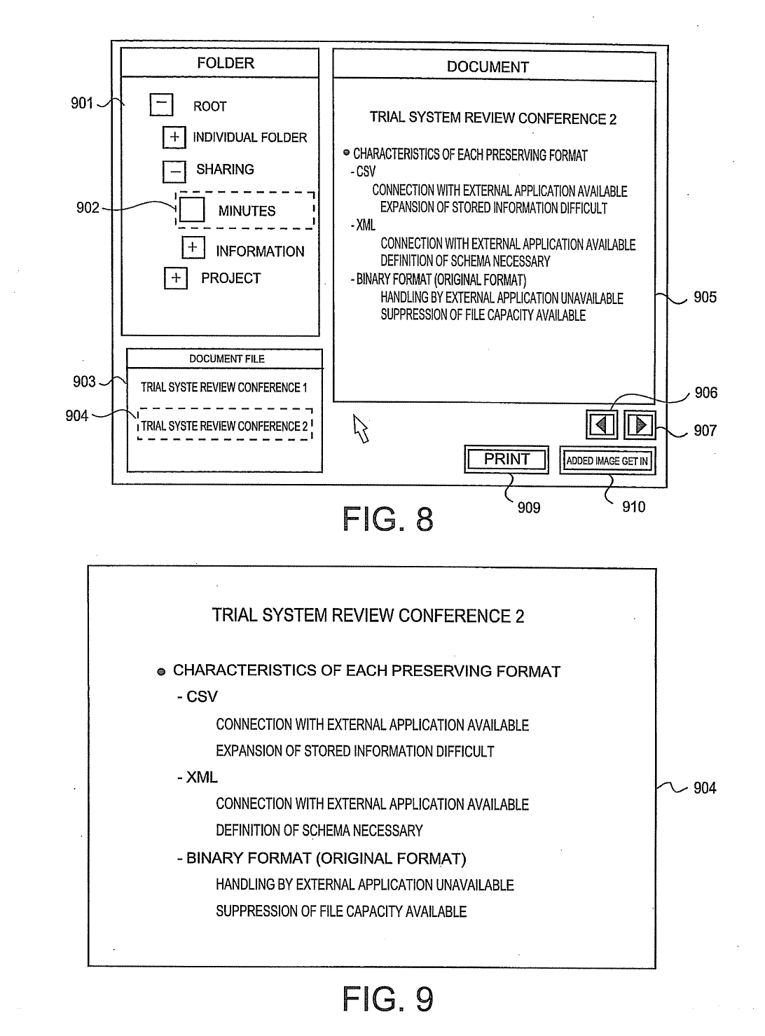

The user can browse the document file stored in the document storing portion 13 of the document administration server 2 by the document browsing portion 21 of the client PC 3. For example, a document browsing application having a screen as shown in FIG. 8 is installed in the client PC 3. The contents of a desired document file can be browsed by the installed document browsing application.

The document browsing application shown in FIG. 8 will be explained. Firstly, in the folder selecting area 901, the folder name of the document file stored in the document storing portion 13 is displayed is a tree form. The user, by clicking the mark + or − beside the folder name, can develop or omit the low order folders. And, he clicks the folder name, thereby can select the folder. The document file list included in the selected folder is displayed in a file selecting area 903. If the desired file name is clicked among the file names displayed in the file selecting area 903, the document file is displayed in a document display area 905.

The display in FIG. 8 will be explained as an example. Here, as a folder, a “conference minutes” folder 902 is selected and the two document files included in the folder 902 are displayed in the document file selecting area 903. Among the two displayed document files, a document file 904 of “trial system review conference 2” is clicked and selected. By the selection, the first page of the document file 904 is displayed in the document display area 905. The first page of the document file 904 is shown in FIG. 9. The user can return the displayed page by clicking a left arrow button 906 or can proceed the page by clicking a right arrow button 907, thereby can confirm the contents of the document file. Further, the document file of “trial system review conference 2” corresponds to a document file 303 shown in FIG. 3.

Further, if a print button 909 is clicked, the document file under browsing can be printed by the printer portion 11. If an added image getting-in button 910 is clicked, the screen relating to the process of adding the added image stored in the added image storing portion 18 to the document file is displayed.

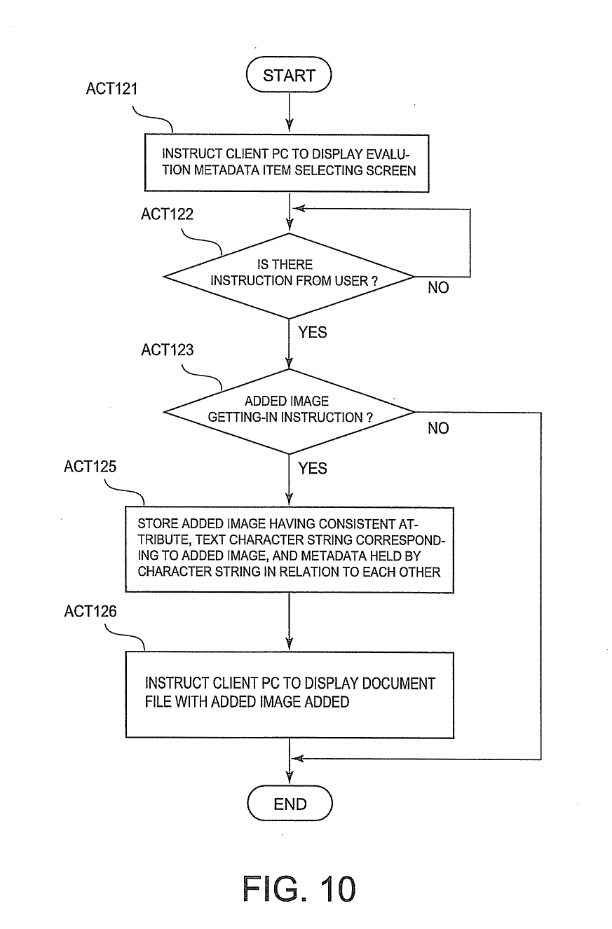

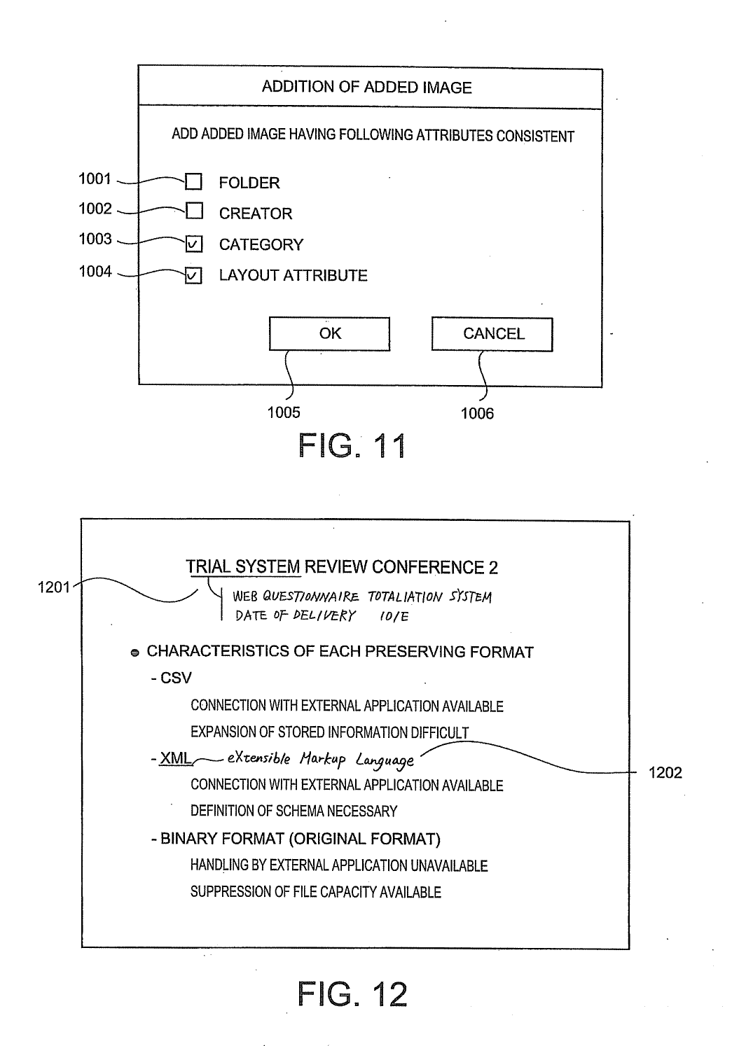

Next, the control for the text metadata selection getting-in by the text metadata selecting portion 19 and the added image getting-in portion 20 will be explained. If the added image getting-in button 910 shown in FIG. 8 is clicked by the user, the control shown in FIG. 10 is started. If the control shown in FIG. 10 is started, the text metadata selecting portion 19 instructs the client PC 3 so as to display the evaluation metadata item selecting screen shown in FIG. 11 (ACT 121). On the evaluation metadata item selecting screen, four metadata items 1001 to 1004 are displayed. The user can select any of the metadata items using the check box of each metadata item. Here, the user waits for selection of the metadata item aimed at by the user.

In FIG. 11, among the metadata items, the check boxes of the category 3 and layout attribute 1004 are checked. Therefore, the text metadata selecting portion 19 is judged as to whether the category and layout attribute among the metadata of the text character string and the metadata of the added image in the document file which are browsed and displayed are consistent. The text metadata selecting portion 19 is judged as to whether an instruction is issued by the user or not (ACT 122). If the instruction is judged as issued (YES at ACT 122), the text metadata selecting portion 19 judges whether the instruction is added image getting-in instruction information or not (ACT 123). The text metadata selecting portion 19, if the instruction is judged not as added image getting-in, that is, is judged as a cancel instruction (NO at ACT 123), finishes the flow. The text metadata selecting portion 19, if the instruction is judged as an added image getting-in instruction (YES at ACT 123), judges the instruction as an instruction of searching for metadata consistent with the attribute and stores the added image consistent with the attribute, the text character string corresponding to the added image, and the metadata of the text character string in the added image storing portion 18 in relation to each other (ACT 125). Further, the added image getting-in portion 20 instructs so as to display the document file with the added image added on the client PC 3 (ACT 126).

An example is shown in FIG. 12. In FIG. 12, two added images are added. The added images are assumed as an added image 1201 and an added image 1202.

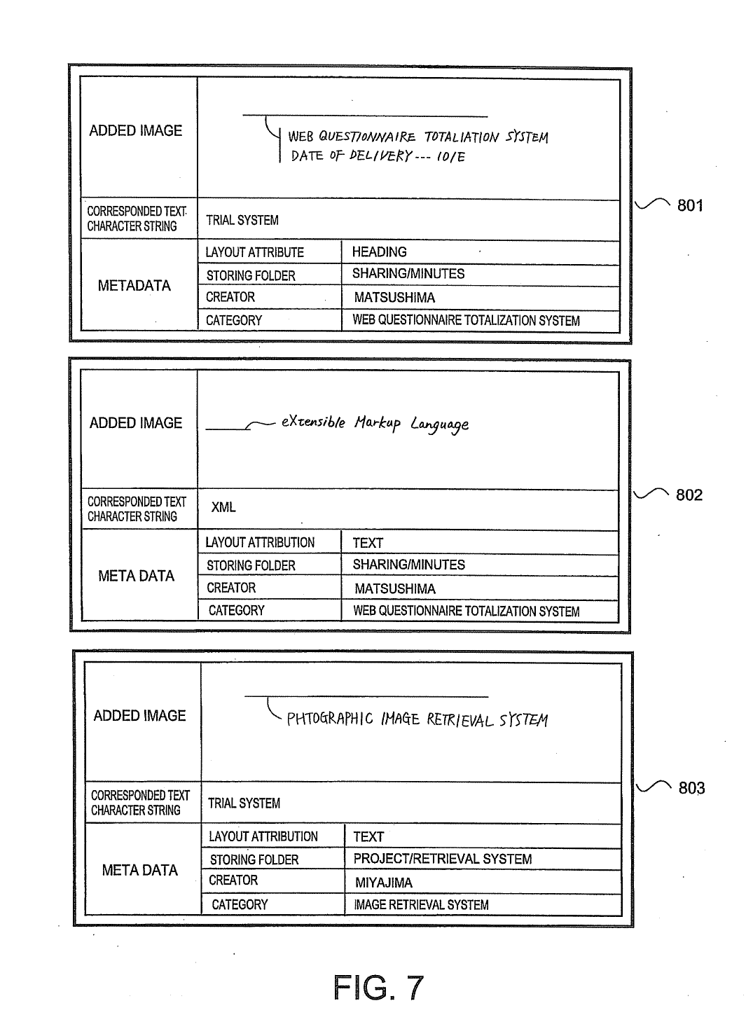

The added image 1201 is an added image indicated by an added image storing format 801 shown in FIG. 7. The added image is an image stored in relation to the text character string of “Trial system”. In the selected document file 904 shown in FIG. 9, there exists the text character string of “Trial system”. If the metadata of the text character string of “Trial system” of the document file 904 is obtained by the text metadata obtaining portion 17, the metadata that the layout attribute is “Heading”, and the folder is “Sharing/Minutes”, and the creator is “Hashidate”, and the category is “Web questionnaire system” is obtained. On the other hand, the metadata of the added image 1201, as shown in FIG. 7, is that the layout attribute is “Heading”, and the folder is “Sharing/Minutes”, and the creator is “Matsushima”, and the category is “Web questionnaire totalization system”.

In this case, on the evaluation metadata item selecting screen shown in FIG. 11, the category 1003 and layout attribute 1004 are selected, so that the metadata of the two items may be consistent between the metadata of the text character string and the metadata of the added image. The two metadata items are consistent, so that the added image indicated by the added image storing format 801 is added to the document file 904 as an added image 1201.

Similarly, the added image 1202 is an added image indicated by an added image storing format 802 shown in FIG. 7. The added image is an image stored in relation to the text character string of “XML” and in the selected document file 904, there exists the text character string of “XML”. If the metadata of the text character string of “XML” of the document file 904 is obtained by the text metadata obtaining portion 17, the metadata that the layout attribute is “Text”, and the folder is “Sharing/Minutes”, and the creator is “Matsushima”, and the category is “Web questionnaire totalization system” is obtained. On the other hand, the metadata of the added image 1202, as shown in FIG. 7, is that the layout attribute is “Text”, and the folder is “Sharing/Minutes”, and the creator is “Matsushima”, and the category is “Web questionnaire totalization system”. At this time, the category and layout attribute of the selected metadata item are consistent, so that the added image indicated by the added image storing format 802 is added to the document file 904 as an added image 1202.

Here, in the added image storing portion 18, as shown in FIG. 7, an added image stored in an added image storing format 803 is stored. With respect to the added image, the related text character string is “Trial system” and there exists the text character string of “Trial system” in the document file 902. However, according to the metadata of “Trial system” of the document file 904 obtained by the text metadata obtaining portion 17, the category is “Web questionnaire system” and the layout attribute is “Heading”. However, the metadata of the added image indicated by the added image storing format 803 is that the category is “Image retrieval system” and the layout attribute is “Text”. Namely, the metadata of the text character string and the metadata of the text character string of the added image do not coincide with the selected metadata item. Therefore, the added image of the added image storing format 803 is not added to the document file 904.

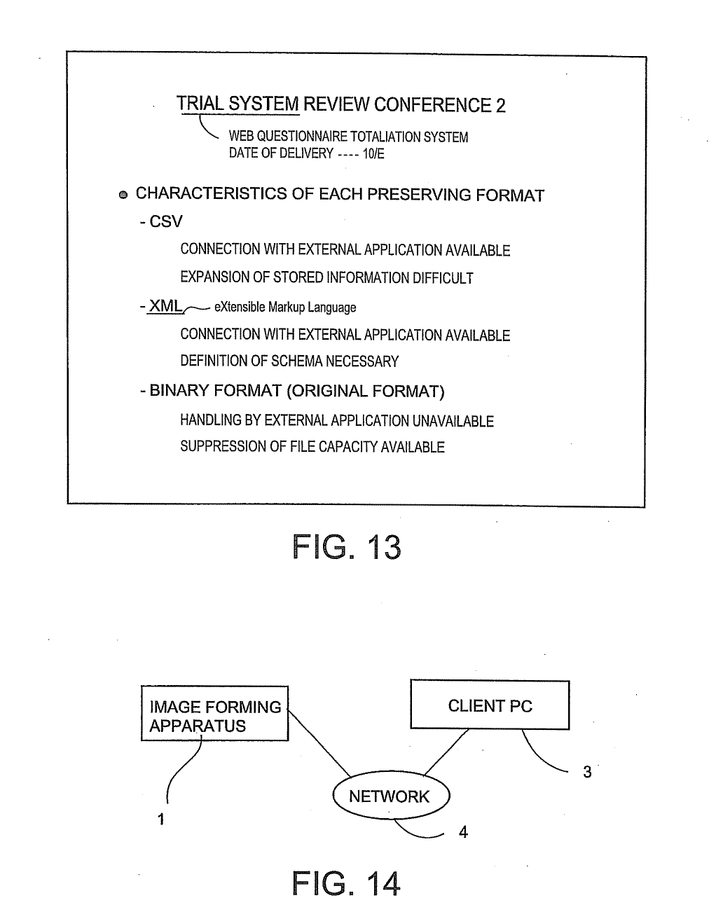

Further, when the added image is a handwritten character string, the added image storing portion 18 has a text character string conversion portion for converting the handwritten character string to the same text character string as the text of the originated print document file from the character information. Instead of the handwritten added image, an added image converted to a text character string may be added. As an example, the document file when the handwritten added images 1210 and 1202 shown in FIG. 12 are converted to a text character string and are added is shown FIG. 13.

By use of the embodiment aforementioned, the added image corresponding to the text character string in the document file can be added to the document file.

The added image corresponds to the text character string in the document, so that when the text character string corresponding to the added image is inserted into a document different from the document from which the added image is extracted, the added image can be inserted into the text character string. Further, the added image is related to the text metadata of the corresponded text character string, so that even when there exist many same texts in the document, the added image can be added only to a text consistent with the text metadata designated by the user. In addition, only when the category of the document and the category of the added image coincide with each other, the added image is inserted, so that an added image which is different from and independent of the category of the document can be prevented from insertion. Namely, the added image can be added only to the text aimed at by the user and the reusability of the added image is raised.

Further, in this embodiment, among the added images extracted from a scanned paper document, the added image judged that there is no corresponding corresponded text character string is ignored in the subsequent process. However, the added image having no corresponded text character string may be stored in relation to the metadata of the document file itself. Instead of the corresponded text character string, if the added image is stored in relation to the position information in the document file, an added image having no corresponded text character string can be used.

Second Embodiment

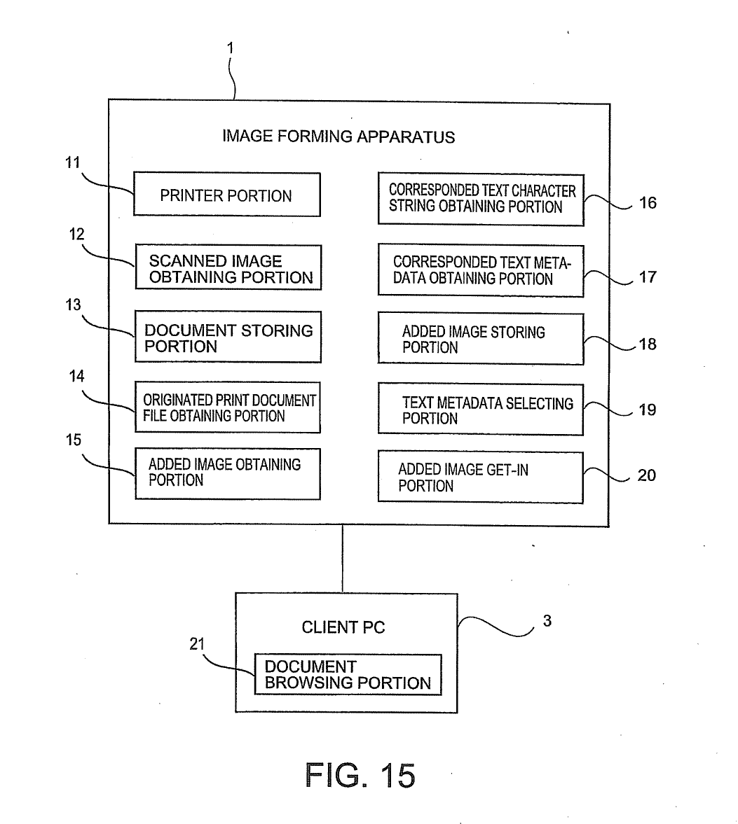

Next, the second embodiment will be explained by referring to FIGS. 14 and 15.

Hereinafter, to the same portions as those of the first embodiment, the same numerals are assigned and only the characteristic portions of this embodiment will be explained.

In this embodiment, the processing portions included in the document administration server 2 in the first embodiment are all included in the image forming apparatus.

FIG. 14 is a block diagram showing the constitution of the added image processing system of this embodiment.

The added image processing system is composed of the image forming apparatus 1 and the client PC 3 and these units transfer information via the network 4.

FIG. 15 is a block diagram showing the processing portions included in the image forming apparatus.

The processing portions having the same names as those of the first embodiment bear respectively the same functions The image forming apparatus, similarly to the first embodiment, includes the printer portion 11, scanned image obtaining portion 12, furthermore, document storing portion 13, originated print document file obtaining portion 14, added image obtaining portion 15, corresponded text character string obtaining portion 16, text metadata obtaining portion 17, added image storing portion 18, text metadata selecting portion 19, and added image getting-in portion 20. The client PC 3, similarly to the first embodiment, has the document browsing portion 21.

The added image extracting process from the scanned paper document and the added image getting-in process to the document file are performed in the same flow by the same processing portions as those of the first embodiment. In this embodiment, the image forming apparatus 1 includes the processing portions included in the document administration server 2 of the first embodiment, so that the scanned image of the paper document read by the image forming apparatus 1 does not need to be sent to the server via the network and is processed in the image forming apparatus 1. Further, when printing the document file for which the added image getting-in process is performed, there is no need for the server to communicate with the image forming apparatus 1 via the network.

Further, in this embodiment, the document browsing portion 21 for browsing the data stored in the document storing portion 13 and added image storing portion 18 by the user is included in the client PC 3, though the document browsing portion may be included in the image forming apparatus 1. This, for example, enables to display the data stored in the document storing portion 13 and the added image storing portion 18 on the control panel included in the image forming apparatus 1 to instruct printing and enables the user to instruct the added image getting-in process to the document file.

Third Embodiment

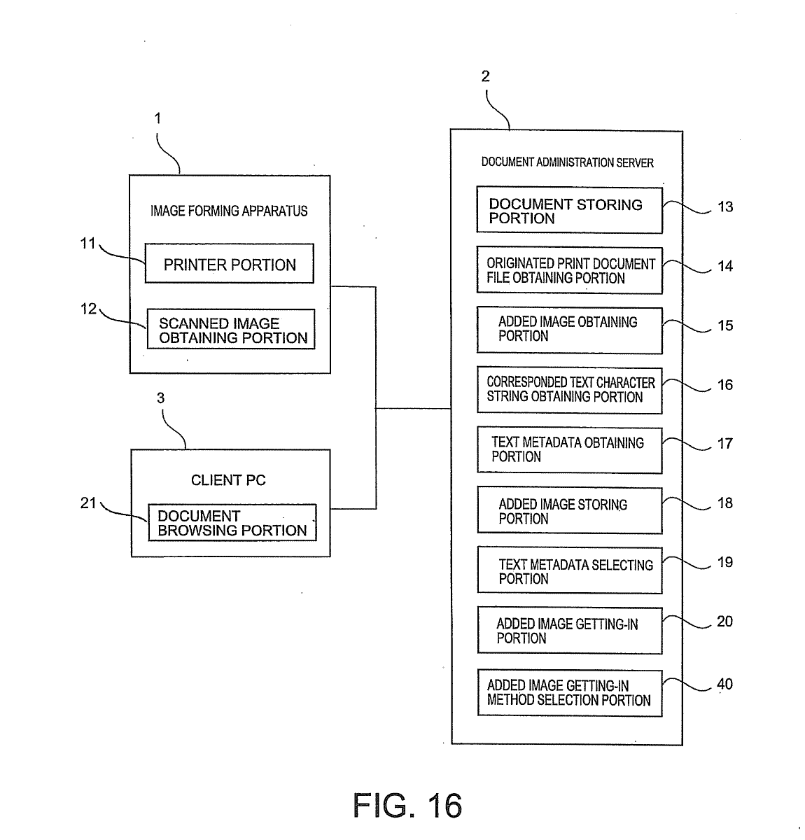

Next, the third embodiment will be explained by referring to FIGS. 16 to 22B.

Hereinafter, to the same portions as those of the first and second embodiments, the same numerals are assigned and only the characteristic portions of this embodiment will be explained.

The block diagram of the processing portions included in the added image processing system of the third embodiment are shown in FIG. 16. This embodiment, in addition to the added image processing system of the first embodiment, includes an added image getting-in method selecting portion 40 enabling the user to select the getting-in method when adding the added image to the document file.

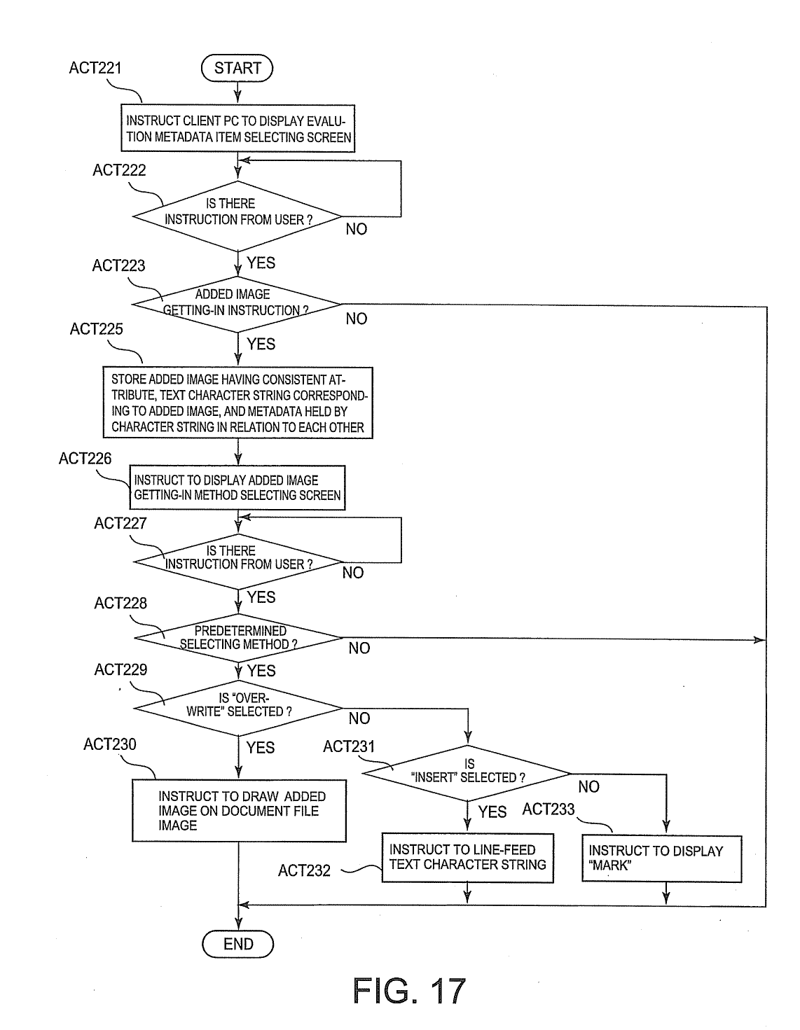

The selection of the added image getting-in method will be explained concretely by referring to the flow chart shown in FIG. 17.

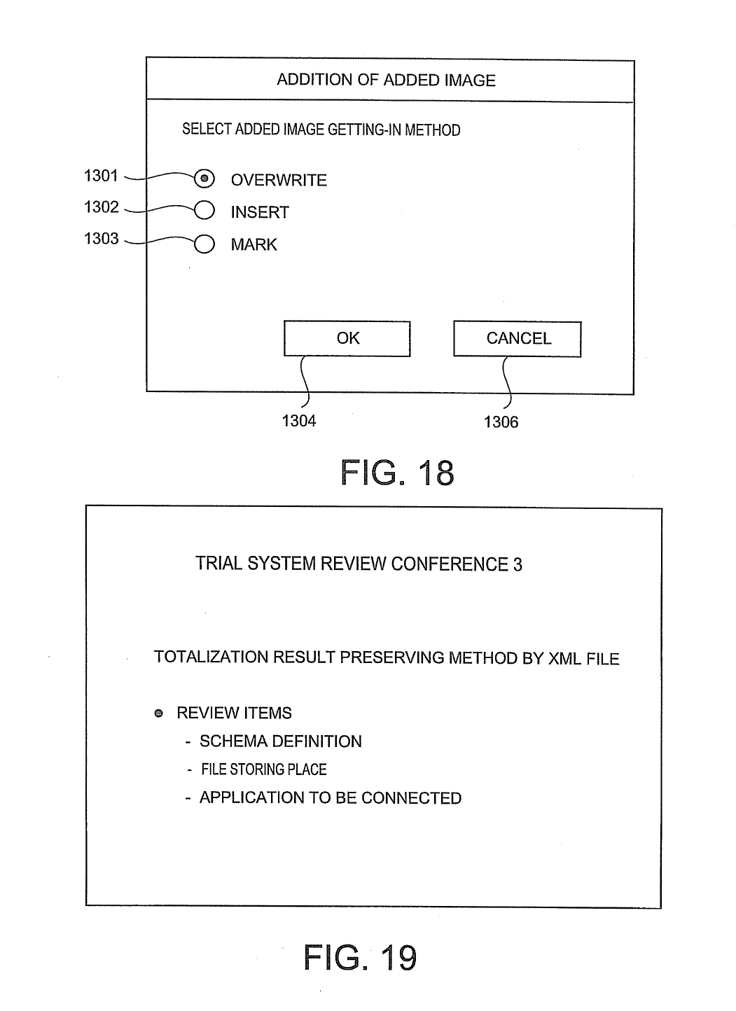

If the user clicks the added image getting-in button 910 on the display screen by the document browsing application shown in FIG. 8, the control of the added image getting-in method shown in FIG. 11 is started. If the control is started, the added image getting-in method selecting portion 40 instructs the client PC 3 so as to display the evaluation metadata item selecting screen shown in FIG. 11 (ACT 221). ACT 221 performs the same operation as that at ACT 121. Therefore, ACT 222 to ACT 225 performs the same operations as those at ACT 122 to ACT 125, so that the explanation will be omitted. After end of the operation at ACT 225, the added image getting-in method selecting portion 40 instructs the client PC 3 so as to display the added image getting-in method selecting screen shown in FIG. 16 (ACT 226). In FIG. 18, as an example of the added image getting-in methods, “Overwrite” 1301, “Insert” 1302, and “Mark” 1303 are shown. The added image getting-in method selecting portion 40 judges whether an instruction is issued by the user or not (ACT 227). When judging that an instruction is issued (YES at ACT 227), the added image getting-in method selecting portion 40 judges whether the instruction is a predetermined selecting method or not (ACT 228). When judging that the instruction is not the instruction information of the predetermined added image getting-in method, that is, judging that the instruction is a cancel instruction (NO at ACT 228), the added image getting-in method selecting portion 40 finishes the flow. The added image getting-in method selecting portion 40, when judging that the instruction is an instruction of the predetermined added image getting-in method (YES at ACT 228), judges whether the instruction is an overwrite instruction or not (ACT 229). When judging that the instruction is an overwrite instruction (YES at ACT 229), the added image getting-in method selecting portion 40 issues an instruction of drawing an added image on the document file image (ACT 230). When judging that the instruction is not the overwrite instruction (NO at ACT 229), the added image getting-in method selecting portion 40 judges whether “Insert” is instructed or not (ACT 231). When judging that “Insert” is instructed (YES at ACT 231), the added image getting-in method selecting portion 40 issues an instruction of line-feeding the text characters (ACT 232). When judging that “Insert” is not instructed (NO at ACT 229), the added image getting-in method selecting portion 40 judges that “Mark” is instructed and issues an instruction of displaying a mark (ACT 233).

If the evaluation metadata item is selected on the evaluation metadata item selecting screen and then an OK button 1005 is clicked, the added image getting-in method selecting screen shown in FIG. 18 is displayed. In FIG. 18, as an example of the added image getting-in methods, the “Overwrite” 1301, “Insert” 1302, and “Mark” 1303 are shown. If the user selects any one from the added image getting-in methods and clicks an OK button 1304, the added image getting-in method selecting portion 40 notifies the added image getting-in method selected by the user to the added image getting-in portion 20. And, the added image getting portion 20 adds the added image by the method selected by the user.

Next, the added image getting-in methods of “Overwrite”, “Insert”, and “Mark” which are shown as an example in FIG. 18 will be explained. For the explanation, the case that the added image corresponding to the text character string of “XML” of the document file shown in FIG. 19 is added is used as an example.

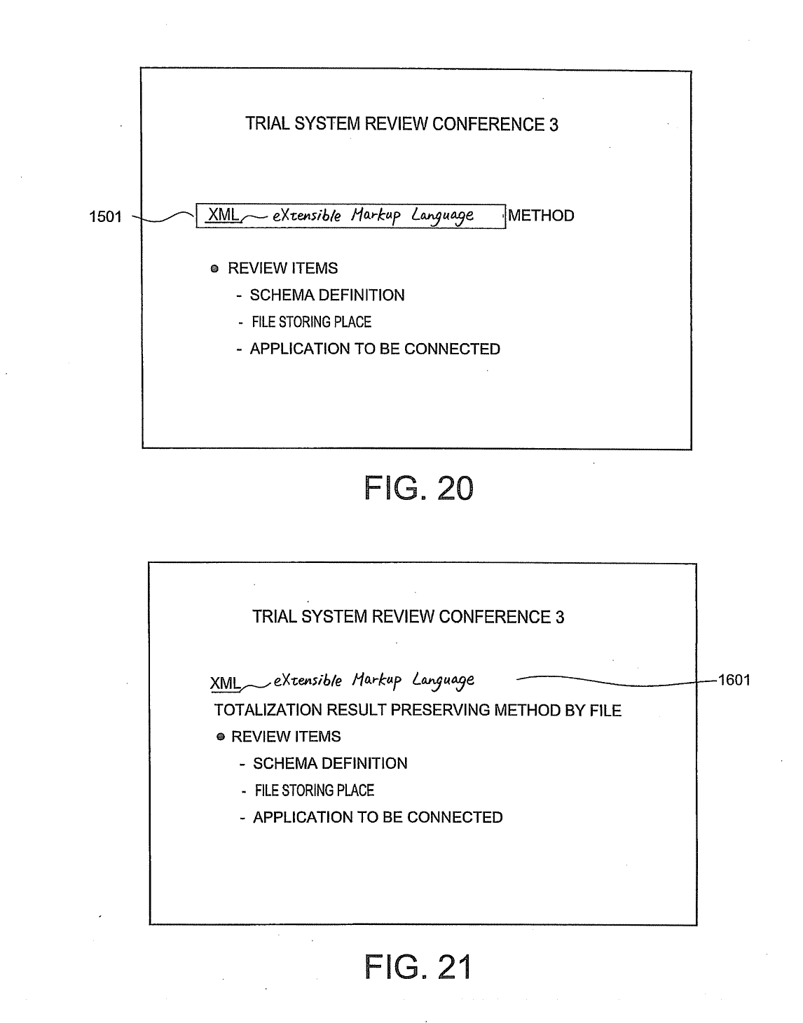

“Overwrite”, as shown in FIG. 20, is a method for drawing an added image on the image of the document file regardless of whether there is the image of the document file at the position where an added image 1501 is added or not.

“Insert” is a method, when adding the added image, for shifting and displaying the image in the document file which comes under the added image and goes out of sight, thereby eliminating the images of the document file which go out of sight due to the added image. Namely, as shown in FIG. 21, an added image 1601 is added. By doing this, the text character string of “On-file totalization result method” which may go out of sight due to addition of the added image 1601 is line-fed, and the text character string is prevented from going out of sight, and the added image is added.

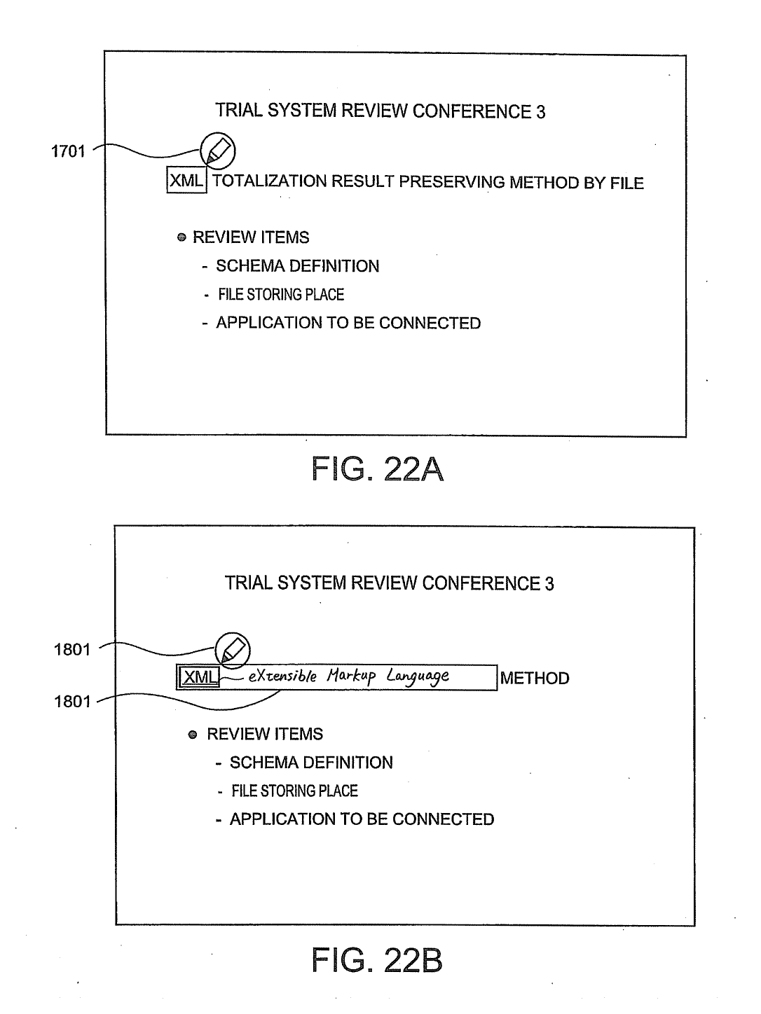

Next, to the “Mark”, as shown in FIG. 22A, an added image mark 1701 is added. If the user clicks the added image mark 1701 on the document, an added image 1801 is developed and displayed as shown in FIG. 22B. This is an effective getting-in method when the document after the added image is added is not printed.

As described in this embodiment, if the user can select the added image getting-in method, the added image getting-in format suited to the case that the user uses the document file can be selected.

What is claimed is:

1. An added image processing system, comprising:
a document storing portion configured to store a document file to be electronic information;
an added image obtaining portion configured to obtain a difference in case comparing the document file stored in the document storing portion identified on the basis of a scanned image obtained by scanning a paper document with the scanned image as an added image;
a corresponded text obtaining portion configured to obtain a text corresponding to the added image obtained by the added image obtaining portion;
a text metadata obtaining portion configured to obtain text metadata of the corresponded text;
an added image storing portion configured to store the corresponded text, the text metadata, and the added image in relation to each other;
an added image getting-in portion, on the basis of the text metadata, configured to add the added image stored in the added image storing portion to a new document file; and
a text metadata selecting portion configured to select an attribute considered in case adding the added image to the new document file by the added image getting-in portion.

2. The system according to claim 1 further comprising:
an added image information getting-in mode selecting portion, in case instructing the attribute considered by the text metadata selecting portion, for further selecting an added image getting-in mode.

3. The system according to claim 2, wherein the mode selected by the added image information getting-in mode selecting portion is an insert.

4. The system according to claim 1, wherein the attribute selected by the text metadata selecting portion is a layout attribute.

5. The system according to claim 1 further comprising:
a printer portion configured to print the document file.

6. The system according to claim 5, wherein the printer portion, in case printing the document file, gives and prints information for identifying the document file.

7. The system according to claim 1, wherein the added image obtaining portion includes an originated print identifying portion and the originated print identifying portion retrieves an image similar to the scanned image by similar image retrieval from the document storing portion, thereby obtains the originated print document file corresponding the scanned image.

8. The system according to claim 1 further comprising:
a text character string conversion portion configured to convert the added image to a text character string as character information,
wherein the text character string conversion portion adds the added image converted to the text character string a new document file.

9. The system according to claim 1, wherein the document storing portion stores also the document metadata of the document file, and the added image storing portion, if the text corresponding to the added image is not obtained by the corresponded text obtaining portion, stores the added image in relation to the document metadata, and the added image getting-in portion can add the added image on the basis of the document metadata.

10. The system according to claim 1 further comprising;
a scanned image obtaining portion configured to obtain the scanned image.

11. An added image processing system, comprising;
a document storing memory to store a document file to be electronic information;
a scanned image memory to store a scanned image obtained by scanning a paper document;
an added image storing memory to obtain a difference in case comparing the document file of the document storing memory identified on the basis of the scanned image with the scanned image as an added image and storing the text metadata of the corresponded text corresponding to the added image and the added image in relation to each other; and
a controller, on the basis of the text metadata, to control to add the added image stored in the added image storing memory to a new document file and select an attribute considered in case adding the added image.

12. The system according to claim 11, wherein the controller, in case instructing the attribute considered by the text metadata selecting portion, further selects an added image getting-in mode.

13. An added image getting-in method, comprising:
storing, using a CPU, a document file to be electronic information;
obtaining, using a CPU, a scanned image of a paper document scanned;
obtaining, using a CPU, a document file corresponding to the scanned image as an originated print document file from the stored document file;
obtaining, using a CPU, a difference in case comparing the originated print document file with the scanned image as an added image and obtaining a text in the originated print document file corresponding to the added image;
storing, using a CPU, the text metadata of the corresponded text and the added image in relation to each other;
selecting, using a CPU, an attribute considered in case adding the added image to the document file; and
adding, using a CPU, the stored added image to the document file on the basis of the selected attribute and the text metadata.

14. The method according to claim 13, wherein the getting-in method used for the getting-in is selected.

15. The method according to claim 13, wherein the paper document is given information identifying the originated print document file.

16. The method according to claim 13, wherein in case obtaining the originated print document file, an image similar to the scanned image is retrieved by similar image retrieval, thus the originated print document file corresponding the scanned image is obtained from the stored document file.

17. The method according to claim 13, wherein in case storing the document file, the document metadata of the document file is also stored, and if the text corresponding to the added image is not obtained, the added image is stored in relation to the document metadata, and the added image is added to the document file on the basis of the document metadata.
